(19) United States
(12) Patent Application Publication
(10) Pub. No.: US 2016/0087680 A1
(43) Pub. Date: Mar. 24, 2016

(54) BROADCAST AUTOMATIC COMMUNICATION METHOD AND SYSTEM THEREOF

(71) Applicant: FLUIDITECH IP LIMITED, VICTORIA (SC)

(72) Inventor: JONATHAN TSAI, Seattle, WA (US)

(21) Appl. No.: 14/721,699

(22) Filed: May 26, 2015

(30) Foreign Application Priority Data
Sep. 19, 2014 (TW) 103132343

(51) Int. Cl. H04B 5/00; H04W 76/02

(52) U.S. Cl. CPC H04B 5/00; H04W 76/023

(57) ABSTRACT

A broadcast automatic communication method and a system thereof are provided. The system applies near field communication assemblies to establish a first far field communication path between far field communication assemblies of first and second electronic devices. The first and second electronic devices respectively produce first and second message packages. The method applies the near field communication assemblies of the first and second electronic devices to form first and second near field communication ranges, respectively. The first and second near field communication ranges are united, a first near field communication path is established, and the first message package is stored in the second electronic device and/or the second message package is stored in the first electronic device. The second or first message package is analyzed to establish the first far field communication path. Disclosure enables numerous electronic devices communicating with each other by broadcasting method.

### CROSS-REFERENCE TO RELATED APPLICATION

This application claims priority from Taiwan Patent Application No. 103132343, filed on Sep. 19, 2014, in the Taiwan Intellectual Property Office, the content of which are hereby incorporated by reference in their entirety for all purposes.

### BACKGROUND OF THE INVENTION

1. Field of the Invention

This application relates to a broadcast automatic communication method and a system thereof, and more particularly, to a broadcast automatic communication method and a system thereof which applies the near field communication to broadcast the message package to establish the far field communication among numerous electronic devices.

2. Description of the Related Art

As far as the current technique is concerned, the near field communication assembly and the far field communication assembly may be both disposed in an electronic device to meet the diverse demands and applications. In addition, the wireless signal of the near field communication assembly is effective within a 10 cm transmitting distance while the far field communication assembly is in effect equal to or greater than a 10 cm transmitting distance.

Generally, the wireless signal is limited to the transmitting distance. The near field communication assembly is favorable to perform communication between two electronic devices within a short distance, and has advantages such as rapid match, high security, low power consumption, and so on. As to the far field communication assembly, it contributes to the distant transmission of messages between two electronic devices.

Although the conventional technique is able to apply the near field communication assembly to perform the far field communication, only one electronic device is served as the medium for exchanging the message packages to enable two electronic devices located in remote end to perform the far field communication. The current technique is incapable of being applied to numerous electronic devices.

As a result, the present invention provides a broadcast automatic communication method and a system thereof which are capable of performing the broadcast session.

### SUMMARY OF THE INVENTION

The first objective of the present invention provides a broadcast automatic communication method which may include numerous electronic devices all disposed with near field communication assemblies and far field communication assemblies. Theses electronic devices may transmit the message packages by the self-owned near field communication assemblies, and when the near field communication is established, the configuration file of the message package is configured to perform the communication through the far field communication assembly.

The second objective of the present invention is further to define theses electronic devices as the upper level electronic device, the basic level electronic device and the lower level electronic device. The upper level electronic device may broadcast the message package to the basic level electronic device and the lower electronic device according to the aforementioned broadcast automatic communication method.

The third objective of the present invention is that the basic electronic device combines the self-owned message package and the message package received from the upper level electronic device, and then transmits the combination to the lower level electronic device according to the aforementioned broadcast automatic communication method.

The fourth objective of the present invention is that one of these electronic devices may further determine whether to receive the message packages transmitted by the remaining electronic devices according to the aforementioned broadcast automatic communication method.

The fifth objective of the present invention is that these electronic devices may establish the state list in the cloud server to enable one of these electronic devices to determine whether to continue receiving the message packages transmitted by the remaining electronic devices based on the usage states of the remaining electronic devices according to the aforementioned broadcast automatic communication method.

The sixth objective of the present invention is that one of these electronic devices may set the self-owned usage state in the cloud server to avoid receiving the message packages transmitted by the remaining electronic devices, as well as the malicious message packages such as spam, advertising information, marketing information, and so on according to the aforementioned broadcast automatic communication method.

The seventh objective of the present invention is to establish the far field communication among numerous electronic devices by the broadcasting method according to a broadcast automatic communication system.

In order to achieve the foregoing and other objectives, the present invention provides a broadcast automatic communication method, which may include applying a near field communication assembly of a first electronic device and a near field communication assembly of a second electronic device to establish a first far field communication path between a far field communication assembly of the first electronic device and a far field communication assembly of the second electronic device. The first electronic device produces a first message package and the second electronic device produces a second message package. The method includes the steps of: starting the near field communication assembly of the first electronic device to form a first near field communication range; starting the near field communication assembly of the second electronic device to form a second near field communication range; uniting the first near field communication range and the second near field communication range to exchange the first message package of the first electronic device and the second message package of the second electronic device; establishing a first near field communication path between the second electronic device and the first electronic device, and storing the first message package in the second electronic device and/or storing the second message package in the first electronic device, and analyzing the second message package or the first message package and establishing the first far field communication path between the first electronic device and the second electronic device.

For the sake of achieving the above-mentioned and other objectives, the present invention further provides a broadcast automatic communication system, which may include a first electronic device and a second electronic device. The first electronic device may include a first processor, a first near field communication assembly, and a first far field communication assembly. The first processor may be connected to the first near field communication assembly and the first far field communication assembly. The first processor may produce a first message package. The first near field communication assembly may produce a first near field communication range to transmit the first message package. The first message package may include a communication configuration file of the first far field communication assembly. The second electronic device may include a second processor, a second near field communication assembly, and a second far field communication assembly. The second processor may be connected to the second near field communication assembly and the second far field communication assembly and may produce a second message package. The second near field communication may produce a second near field communication range to unite the first near field communication range of the first near field communication assembly, and exchange the first message package and the second message package. A first near field communication path may be established between the first electronic device and the second electronic device, the first message package may be stored in the second electronic device and/or the second message package may be stored in the first electronic device. The second message package or the first message package may be analyzed, and the first far field communication path may be established between the first electronic device and the second electronic device. The second message package may include a communication configuration file of the second far field communication assembly.

In addition, the broadcast automatic communication system may further include a third electronic device which may include a third processor, a third near field communication assembly and a third far field communication assembly. The third processor may be connected to the third near field communication assembly and the third far field communication assembly. The third near field communication assembly may produce a third near field communication range to unite the second near field communication range of the second near field communication assembly and exchange the second message package and the third message package produced by the third processor. A second near field communication path may be established between the second electronic device and the third electronic device. The second message package or the third message package may be analyzed, and the second far field communication path may be established between the second electronic device and the third electronic device. When the first message package is stored in the second electronic device, the second electronic device may broadcast the first message package to the third electronic device, and the third electronic device may analyze first message package to establish a third far field communication path between the first electronic device and the third electronic device.

Alternatively, the third near field communication assembly may produce the third near field communication range to unite the first near field communication range of the first near field communication assembly to exchange the first message package and the third message package produced by the third processor. A third near field communication path may be established between the first electronic device and the third electronic device. The first message package or a third message package may be analyzed to establish a fourth far field communication path between the first electronic device and the third electronic device. When the second message package is stored in the first electronic device, the first electronic device may broadcast the second message package to the third electronic device, and the third electronic device may analyze the second message package to establish a fifth far field communication path between the second electronic device and the third electronic device.

As a result, the broadcast automatic communication method and a system thereof are able to apply numerous individual electronic devices such as the first electronic device, the second electronic device, and the third electronic device to exchange the first message package and the second message package between the first electronic device and the second electronic device through the near field communication by means of the broadcasting method.

When the third electronic device and the second electronic device perform the near field communication, by analyzing the first message package and the second message package in the second electronic device directly enables the third electronic device performing the far field communication with the first electronic device, or directly enables the third electronic device performing the far field communication with the second electronic device without the near field communication performed between the first electronic device and the third electronic device.

### BRIEF DESCRIPTION OF THE DRAWINGS

Hereinafter, embodiments of the present invention will be described in detail with reference to the accompanying drawings so that those skilled in the art to which the present invention pertains can realize the present invention, wherein:

FIG. 1 is a flow chart of the first embodiment of a broadcast automatic communication method of the present invention.

FIG. 2 is a schematic diagram of a communication of a first message package and a second message package of the present invention as shown in FIG. 1.

FIG. 3 is a flow chart of the second embodiment of a broadcast automatic communication method of the present invention.

FIG. 4 is a schematic diagram of a communication between a first message package and a third message package of the present invention as shown in FIG. 3.

FIG. 5 is a flow chart of the third embodiment of a broadcast automatic communication method of the present invention.

FIG. 6 is a schematic diagram of a communication among a first message package, a second message package and a third message package of the present invention as shown in FIG. 5.

FIG. 7 is a flow chart of the fourth embodiment of a broadcast automatic communication method of the present invention.

FIG. 8 is a flow chart of the fifth embodiment of a broadcast automatic communication method of the present invention.

FIG. 9 is a block diagram of an embodiment of a broadcast automatic communication system of the present invention.

### DETAILED DESCRIPTION OF THE PREFERRED EMBODIMENTS

Hereinafter, embodiments of the present invention will be described in detail with reference to the accompanying drawings so that those skilled in the art to which the present invention pertains can realize the present invention. As those skilled in the art would realize, the described embodiments may be modified in various different ways, all without departing from the spirit or scope of the present invention.

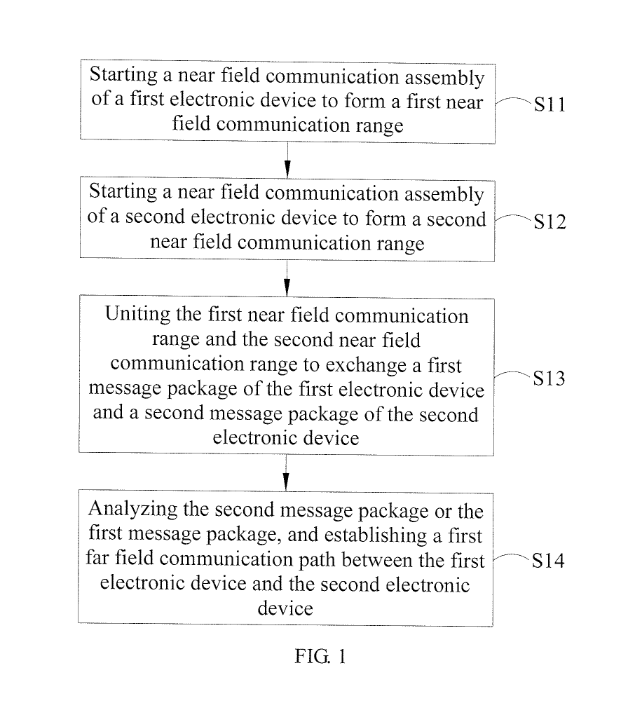

Please refer to FIG. 1 which is a flow chart of the first embodiment of a broadcast automatic communication method of the present invention. In the broadcast automatic communication method, a near field communication assembly of a first electronic device SD1 and a near field communication assembly of a second electronic device SD2 are applied to perform the near field communication (NFC), and the near field communication assembly may match at least one of Near Field Communication Protocol and Bluetooth Communication Protocol.

The first electronic device SDI produces a first message package FMP, and the second electronic device SD2 produces a second message package SMP. The first message package FMP and the second message package SMP may include plural columns which are used to store messages respectively. These columns may further be defined such as device code, data length, data attribute, data bit number, communication address, detection number, and so on.

When the first electronic device SD1 and the second electronic device SD2 performed the near field communication, the far field communication assembly of the first electronic device SD1 and the far field communication assembly of the second electronic device SD2 establish a first far field communication path FFCP. The far field communication assembly may match at least one of Wi-Fi communication protocol, Wireless Universal Serial Bus, and Internet Protocol.

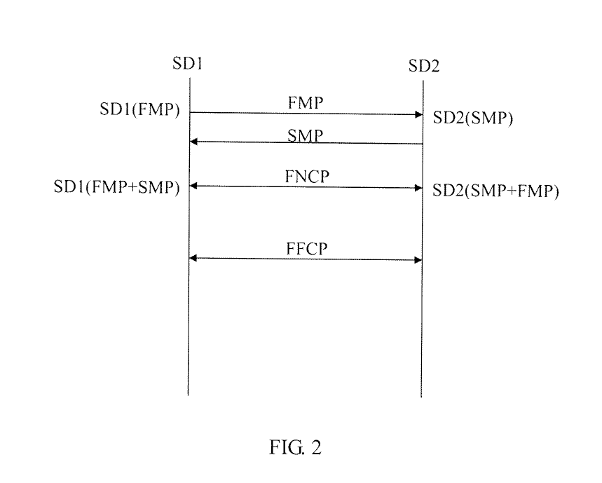

Please refer to FIG. 2 which is a schematic diagram of a communication of the first message package FMP and the second message package SMP between the first electronic device SD1 and the second electronic device SD2 of the present invention as shown in FIG. 1.

The broadcast automatic method includes the following steps. Step S11: a near field communication assembly of the first electronic device SD1 is started to form a near field communication range. In the embodiment, the near field communication assembly matches the near field communication protocol. Thus, the wireless signal of the near field communication assembly may be valid at a 10 cm transmitting distance.

Step S12: a near field communication assembly of the second electronic device SD2 is started to form a second near field communication range. In the embodiment, the near field communication assembly also matches the near field communication protocol.

Step S13: the first near field communication range and the second near field communication range are united to exchange the first message package FMP of the first electronic device SD1 and the second message package SMP of the second electronic device SD2. A first near field communication path FNCP is established between the second electronic device SD2 and the first electronic device SD1. The first message package FMP is stored in the second electronic device SD2 and/or the second message package SMP is stored in the first electronic device SD1. In other words, the first electronic device SD1 and the second electronic device SD2 apply the near field communication to exchange the message packages with each other, so that the first electronic device SD1 and the second electronic device SD2 have self-owned message package, and are also able to store the message package of the counterpart.

In addition, two electronic devices are applied as an example for more details. The numerous electronic devices applied in the embodiment may use the broadcasting method to enable one of these electronic devices to randomly connect to one of the remaining electronic devices via the near field communication. The details will be described in the following paragraphs.

Step S14: the second message package SMP or the first message package FMP is analyzed, and the first far field communication path FFCP is established between the first electronic device SD1 and the second electronic device SD2.

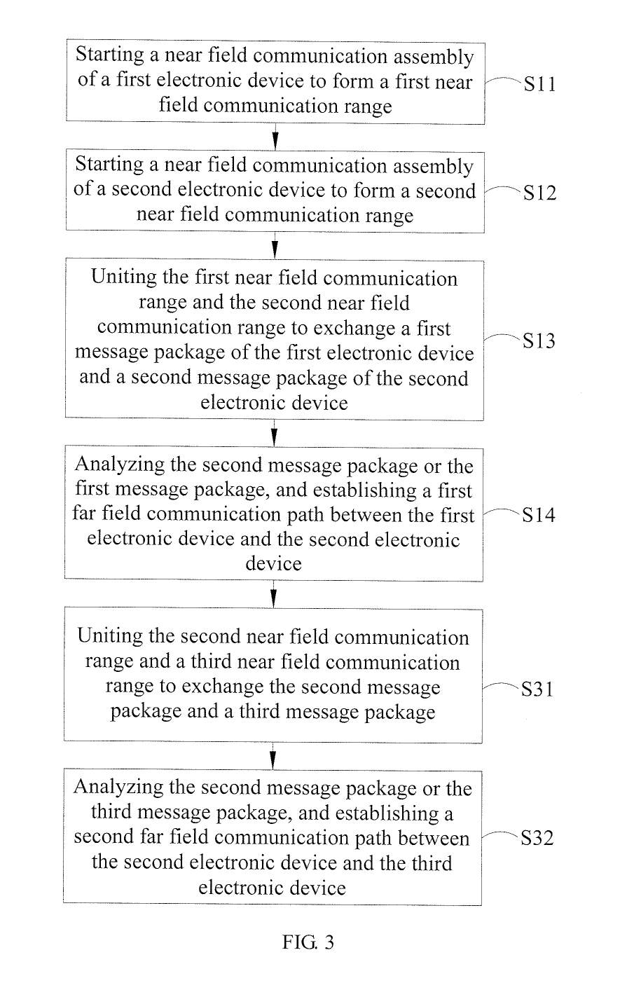

Please refer to FIG. 3 which is a flow chart of the second embodiment of a broadcast automatic communication method of the present invention. In FIG. 1, excepting for the first electronic device SD1 and the second electronic device SD2 shown in first embodiment, the broadcast automatic communication method further includes a third electronic device SD3.

The third electronic device SD3 applies the self-owned near field communication assembly to form a third near field communication range, and produces a third message package TMP.

The broadcast automatic communication method includes the steps of S11 to S14 of the first embodiment, and further includes the steps of S31 and S32.

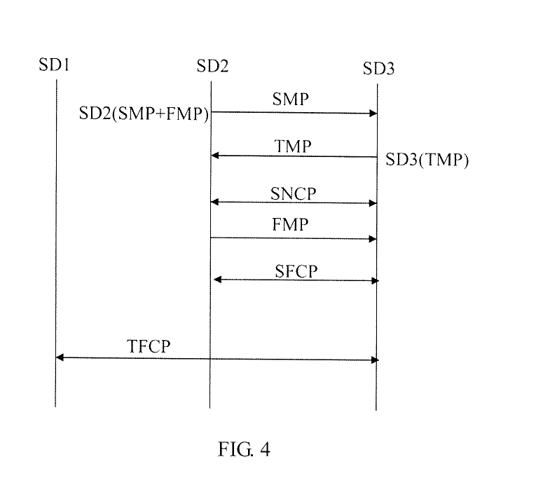

Please refer to FIG. 4 which is a schematic diagram of a communication of the first message package FMP and the third message package TMP between the second electronic device SD2 and the third electronic device SD3 of the present invention as shown in FIG. 3.

Step S31: the second near field communication range and a third near field communication range are united to exchange the second message package SMP and the third message package TMP, and a second near field communication path SNCP is established between the second electronic device SD2 and the third electronic device SD3.

Step S32: the second message package SMP or the third message package TMP is analyzed, and a second far field communication path SFCP is established between the second electronic device SD2 and third electronic device SD3. When the first message package FMP is stored in the second electronic device SD2, the second electronic device SD2 also broadcasts the first message package FMP to the third electronic device SD3 to enable the third electronic device SD3 and the first electronic device SD1 to establish a third far field communication path TFCP. If the first message package FMP is not stored in the second electronic device SD2, the second electronic device SD2 only broadcasts the second message package SMP to the third electronic device SD3 to enable the third electronic device SD3 and the second electronic device SD2 to establish the second far field communication path SFCP.

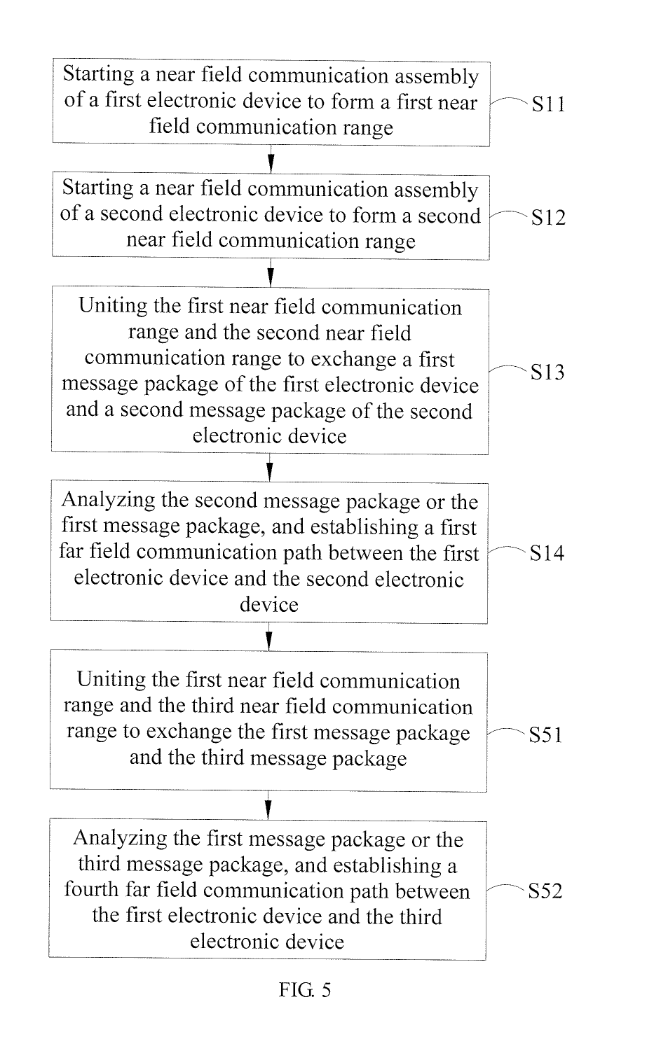

Please refer to FIG. 5 which is a flow chart of the third embodiment of a broadcast automatic communication method of the present invention. In the FIG. 5, the broadcast automatic communication method includes the first electronic device SD1 and the second electronic device SD2 applied in the first embodiment and the third electronic device SD 3 applied in the second embodiment.

The broadcast automatic communication method includes the steps of S11 to S14 of the first embodiment, and further includes the steps of S51 and S52.

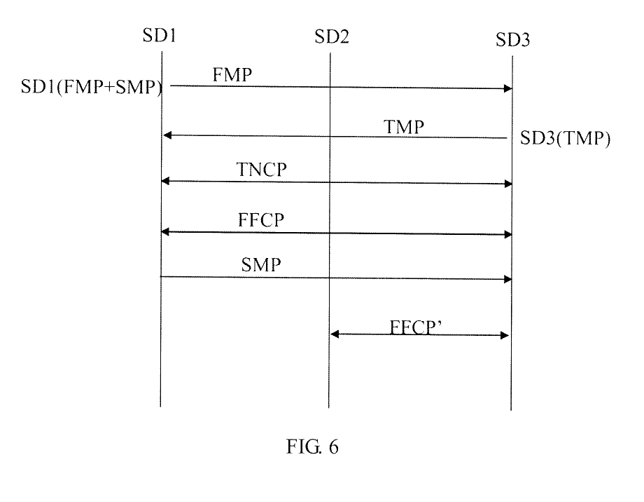

Please refer to FIG. 6 which is a schematic diagram of a communication of the first message package FMP, the second message package SMP and the third message package TMP among the first message package SD1, the second message package SD2 and the third message package SD3 of the present invention as shown in FIG. 5.

Step S51: the first near field communication range and a third near field communication range are united to exchange the first message package FMP and the third message package TMP, and a third near field communication path TNCP is established between the first electronic device SD1 and the third electronic device SD3.

Step S52: the first message package FMP or the third message package TMP is analyzed, and a fourth far field communication path FFCP′ is established between the first electronic device SD1 and the third electronic device SD3. When the second message package SMP is stored in the first electronic device SD1, the first electronic device SD1 also broadcasts the second message package SMP to the third electronic device SD3 to enable the third electronic device SD3 and the second electronic device SD2 to establish a fifth far field communication path FFCP″. If the second message package SMP is not stored in the first electronic device SD1, the first electronic device SD1 only broadcasts the first message package FMP to the third electronic device SD3 to enable the third electronic device SD3 and the first electronic device SD1 to establish the third far field communication path TFCP.

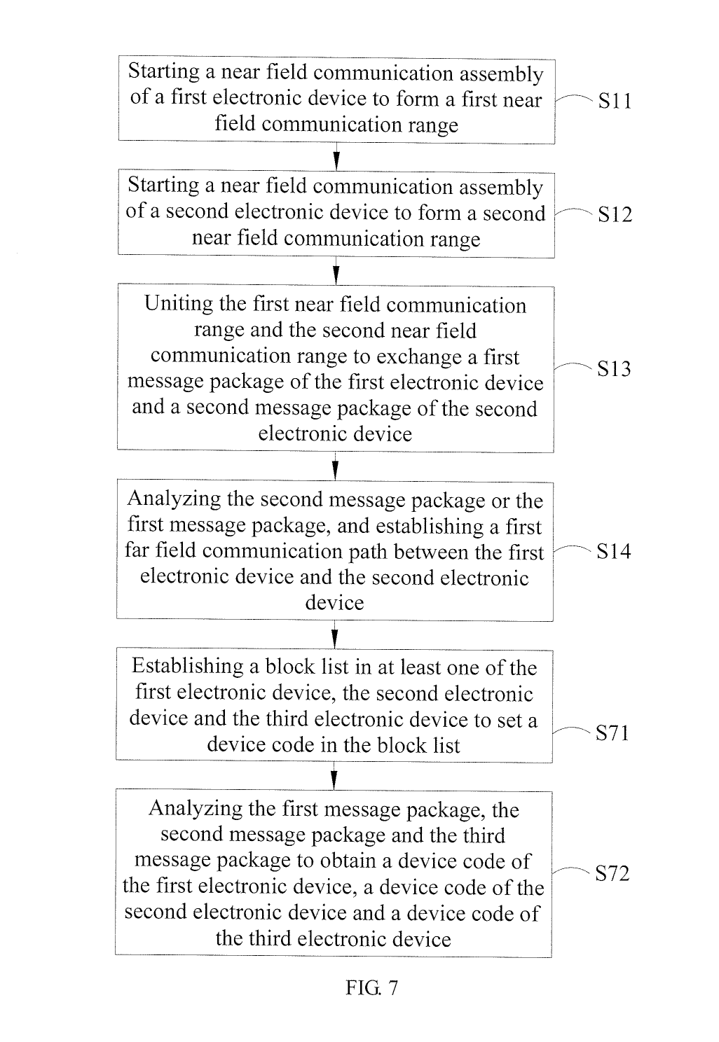

Please refer to FIG. 7 which is a flow chart of the fourth embodiment of a broadcast automatic communication method of the present invention. In the FIG. 7, the broadcast automatic communication method includes the first electronic device SD1 and the second electronic device SD2 applied in the first embodiment and the third electronic device SD3 applied in the second embodiment.

The broadcast automatic communication method includes the steps of S11 to S14 of the first embodiment, and further includes the steps of S71 and S72.

Step S71: a block list is established in at least one of the first electronic device SD1, the second electronic device SD2 and the third electronic device SD3, and a device code is set in the block list. The device code indicates the device identification of the first electronic device SD1, the second electronic device SD2 and the third electronic device SD3.

Step S72: the first message package FMP, the second message package SMP and the third message package TMP are analyzed to obtain a device code of the first electronic device SD1, a device code of the second electronic device SD2 and a device code of the third electronic device SD3.

In the embodiment, if the device code of the second electronic device SD2 and the device code of the third electronic device SD3 have been blocked/tagged in the block list of the first electronic device SD1, the first electronic device SD1 neglects the second message package SMP from the second electronic device SD2 and the third message package TMP from the third electronic device SD3. The same block mode is suitable for the second electronic device SD2 and the third electronic device SD3.

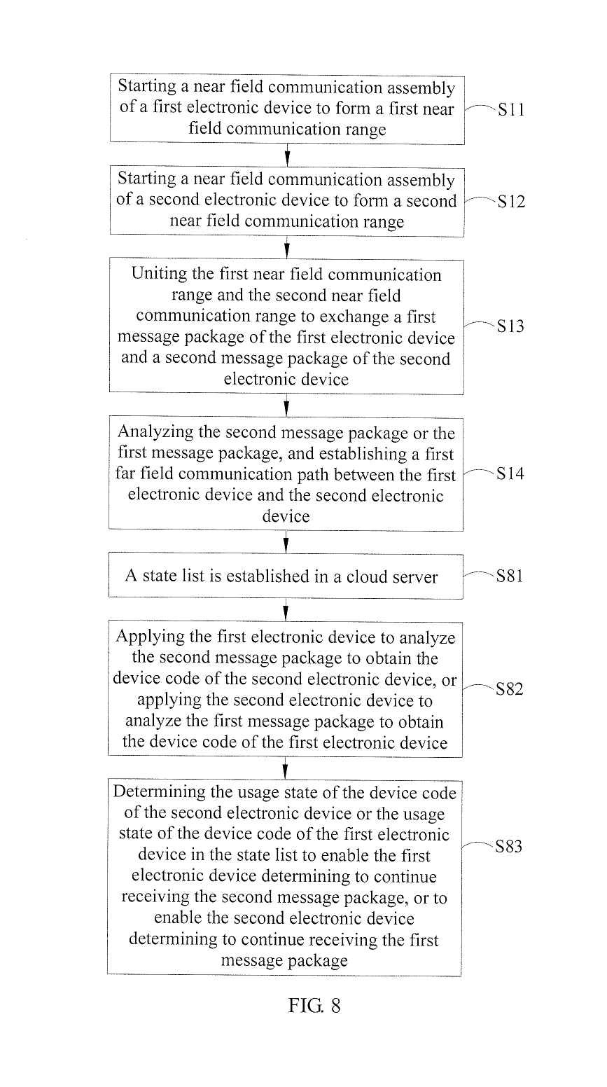

Please refer to FIG. 8 which is a flow chart of the fifth embodiment of a broadcast automatic communication method of the present invention. The broadcast automatic communication method includes the first electronic device SD1 and the second electronic device SD2 applied in the first embodiment.

The broadcast automatic communication method includes the steps of S11 to S14 of the first embodiment, and further includes the steps of S81 to S83.

Step S81: a state list is established in a cloud server, and usage states of the device code of the first electronic device SD1 and the device code of the second electronic device SD2 are stored in the state list. The usage state is divided into effective state and ineffective state. For example, if the device code of the first electronic device SD1 is set as the effective state, the second electronic device SD2 is able to transmit the second message package SMP to the first electronic device SD1. Contrarily, if the device code of the first electronic device SD1 is set as the ineffective state, the second electronic device SD2 fails to establish the far field communication path with the first electronic device SD1. Consequently, the second electronic device SD2 is unable to transmit the second message package SMP to the first electronic device SD1. The same setting mode is suitable for the second electronic device SD2.

Step S82: the first electronic device SD1 is applied to analyze the second message package SMP to obtain the device code of the second electronic device SD2, or the second electronic device SD2 is applied to analyze the first message package FMP to obtain the device code of the first electronic device SD1.

Step S83: the usage state of the device code of the second electronic device SD2 or the usage state of the device code of the first electronic device SD1 is determined in the state list to enable the first electronic device SD1 determining to continue receiving the second message package SMP, or to enable to second electronic device SD2 determining to continue receiving the first message package FMP.

In the embodiment the step further includes deleting the ineffective device code of the second electronic device SD2 from the first electronic device SD1, and deleting the ineffective device code of the first electronic device SD1 from the second electronic device SD2.

In another embodiment the step further includes setting the usages states of the device code of the first electronic device SD1 and the device code of the second electronic device SD2 in the state list. The holder of these electronic devices is able to set the usage states of the first electronic device SD1 and the second electronic device SD2 in the state list.

Moreover, in the other embodiment, the cloud server may be set by a cloud administrator. The cloud administrator is neither the holder of the first electronic device SD1 nor the second electronic device SD2, but the cloud administrator is able to correct the usage state of the device code of the first electronic device SD1 and the usage state of the device code of the second electronic device SD2 in the state list.

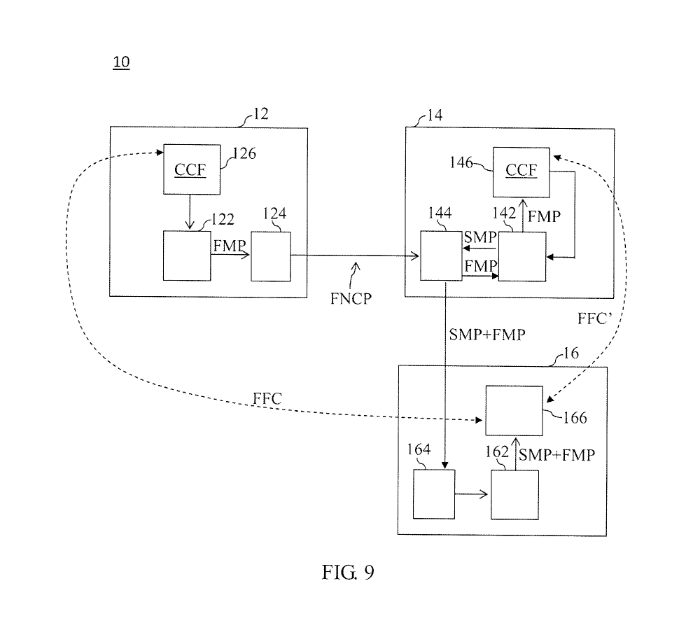

Please refer to FIG. 9 which is a block diagram of an embodiment of a broadcast automatic communication system of the present invention. In the FIG. 9, the broadcast automatic communication system includes a first electronic device 12, a second electronic device 14, and a third electronic device 16.

The first electronic device 12 includes a first processor 122, a first near field communication assembly 124, and a first far field communication assembly 126. The first processor 122 is connected to the first near field communication assembly 124 and the first far field communication assembly 126. The first processor 122 produces a first message package FMP. The first near field communication assembly 124 transmits the first message package FMP, wherein the first message package FMP includes a communication configuration file CCF of the first far field communication assembly 126.

The second electronic device 14 includes a second processor 142, a second near field communication assembly 144, and a second far field communication assembly 146. The second processor 142 is connected to the second near field communication assembly 144 and the second far field communication assembly 146, and produces a second message package SMP. The second near field communication 144 is connected to the first near field communication assembly 124 to receive the first message package FMP. The first message package FMP is stored in the second electronic device 14. The second message package SMP includes a communication configuration file CCF of the second far field communication assembly 143.

The third electronic device 16 includes a third processor 162, a third near field communication assembly 164, and a third far field communication assembly 166. The third processor 162 is connected to the third near field communication assembly 164 and the third far field communication assembly 166. The third near field communication assembly 164 is connected to the second near field communication assembly 144 to receive the first message package FMP and the second message package SMP from the second electronic device 14. The first message package FMP is analyzed to establish a far field communication FFC between the first electronic device 12 and the third electronic device 16, or the second message package SMP is analyzed to establish another far field communication FFC' between the second electronic device 14 and the third electronic device 16.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A broadcast automatic communication method, characterized by applying a near field communication assembly of a first electronic device and a near field communication assembly of a second electronic device to establish a first far field communication path between a far field communication assembly of the first electronic device and a far field communication assembly of the second electronic device, wherein the first electronic device produces a first message package and the second electronic device produces a second message package, and the method comprising steps of:
starting the near field communication assembly of the first electronic device to form a first near field communication range;
starting the near field communication assembly of the second electronic device to form a second near field communication range;
uniting the first near field communication range and the second near field communication range to exchange the first message package of the first electronic device and the second message package of the second electronic device; establishing a first near field communication path between the second electronic device and the first electronic device, and storing the first message package in the second electronic device and/or storing the second message package in the first electronic device, and
analyzing the second message package or the first message package, and establishing the first far field communication path between the first electronic device and the second electronic device.

2. The broadcast automatic communication method of claim 1, further comprising steps of:
uniting the second near field communication range and a third near field communication range to exchange the second message package and a third message package, and establishing a second near field communication path between the second electronic device and a third electronic device, wherein a near field communication assembly of the third electronic device forms the third near field communication range, and the third electronic device produces the third message package, and
analyzing the second message package or the third message package, and establishing a second far field communication path between the second electronic device and the third electronic device;
wherein when the second electronic device stores the first message package, the second electronic device broadcasts the first message package to the third electronic device to enable a third far field communication path being established between the third electronic device and the first electronic device.

3. The broadcast automatic communication method of claim 2, further comprising steps of:
establishing a block list in at least one of the first electronic device, the second electronic device and the third electronic device, and setting a device code in the block list,
analyzing the first message package, the second message package and third message package to obtain the device code of the first electronic device, the device code of the second electronic device and the device code of the third electronic device, and
the first electronic device neglecting at least one of the second message package of the second electronic device and the third message package of the third electronic device, the second electronic device neglecting at least one of the first message package of the first electronic device and the third message package of the third electronic device, and the third electronic device neglecting at least one of the first message package of the first electronic device and the second message package of the second electronic device according to the block list.

4. The broadcast automatic communication method of claim 1, further comprising steps of:
uniting the first near field communication range and a third near field communication range to exchange the first message package and a third message package, and establishing a third near field communication path between the first electronic device and a third electronic device, wherein a near field communication assembly of the third electronic device forms the third near field communication range, and the third electronic device produces the third message package, and
analyzing the first message package or the third message package, and establishing a fourth far field communication path between the first electronic device and the third electronic device;
wherein when the first electronic device stores the second message package, the first electronic device broadcasts the second message package to the third electronic device to enable a fifth far field communication path being established between the third electronic device and the second electronic device.

5. The broadcast automatic communication method of claim 3, further comprising steps of:
establishing a block list in at least one of the first electronic device, the second electronic device and the third electronic device, and setting a device code in the block list,
analyzing the first message package, the second message package and third message package to obtain the device code of the first electronic device, the device code of the second electronic device and the device code of the third electronic device, and
the first electronic device neglecting at least one of the second message package of the second electronic device and the third message package of the third electronic device, the second electronic device neglecting at least one of the first message package of the first electronic device and the third message package of the third electronic device, and the third electronic device neglecting at least one of the first message package of the first electronic device and the second message package of the second electronic device according to the block list.

6. The broadcast automatic communication method of claim 1, further comprising steps of:
establishing a block list in at least one of the first electronic device and the second electronic device, and setting a device code in the block list,
analyzing the first message package and the second message package to obtain the device code of the first electronic device and the device code of the second electronic device, and
the first electronic device neglecting the second message package of the second electronic device and the second electronic device neglecting the first message package of the first electronic device according to the block list.

7. The broadcast automatic communication method of claim 1, further comprising steps of:
establishing a state list in a cloud server, and storing a usage state of a device code of the first electronic device and a usage state of a device code of the second electronic device in the state list,
applying the first electronic device to analyze the second message package to obtain the device code of the second electronic device, or applying the second electronic device to analyze the first message package to obtain the device code of the first electronic device, and
determining the usage state of the device code of the second electronic device or the usage state of the device code of the first electronic device in the state list to enable the first electronic device determining to continue receiving the second message package or to enable the second electronic device determining to continue receiving the first message package.

8. The broadcast automatic communication method of claim 6, further comprising step of:
deleting an ineffective device code of the second electronic device from the first electronic device, and deleting an ineffective device code of the first electronic device from the second electronic device.

9. The broadcast automatic communication method of claim 6, further comprising steps of:
setting a usage state of the device code of the first electronic device and a usage state of the device code of the second electronic device in the state list.

10. A broadcast automatic communication system, comprising:
a first electronic device, comprising a first processor, a first near field communication assembly and a first far field communication assembly; the first processor being connected to the first near field communication assembly and the first far field communication assembly, the first processor producing a first message package, the first near field communication assembly producing a first near field communication range to transmit the first message package, wherein the first message package comprises a communication configuration file of the first far field communication assembly;
a second electronic device, comprising a second processor, a second near field communication assembly and a second far field communication assembly; the second processor being connected to the second near field communication assembly and the second far field communication assembly and producing a second message package, the second near field communication producing a second near field communication range to unite the first near field communication range of the first near field communication assembly and exchange the first message package and the second message package; establishing a first near field communication path between the first electronic device and the second electronic device, the first message package being stored in the second electronic device and/or the second message package being stored in the first electronic device, and analyzing the second message package or the first message package, and establishing a first far field communication path between the first electronic device and the second electronic device, wherein the second message package comprises a communication configuration file of the second far field communication assembly.

11. The broadcast automatic communication system of clam 10, further comprising:
a third electronic device, comprising a third processor, a third near field communication assembly and a third far field communication assembly; the third processor being connected to the third near field communication assembly and the third far field communication assembly, the third near field communication assembly producing a third near field communication range to unite the second near field communication range of the second near field communication assembly and exchange the second message package and the third message package produced by the third processor; establishing a second near field communication path between the second electronic device and the third electronic device; analyzing the second message package or the third message package, and establishing a second far field communication path between the second electronic device and the third electronic device; when the first message package is stored in the second electronic device, the second electronic device broadcasts the first message package to the third electronic device, and the third electronic device analyzes first message package to establish a third far field communication path between the first electronic device and the third electronic device,
alternatively, the third near field communication assembly producing the third near field communication range to unite the first near field communication range of the first near field communication assembly and exchange the first message package and the third message package produced by the third processor; establishing a third near field communication path between the first electronic device and the third electronic device, and analyzing the first message package or a third message package and establishing a fourth far field communication path between the first electronic device and the third electronic device; when the second message package is stored in the first electronic device, the first electronic device broadcasts the second message package to the third electronic device, and the third electronic device analyzes the second message package to establish a fifth far field communication path between the second electronic device and the third electronic device.

12. The broadcast automatic communication system of claim 10, wherein the first near field communication assembly, the second near field communication assembly and the third near field communication assembly match at least one of near field communication protocol and Bluetooth communication protocol, and the first far field communication assembly, the second far field communication assembly and the third far field communication assembly match at least one of Bluetooth communication protocol, Wi-Fi communication protocol, Wireless Universal Serial Bus and Internet Protocol.
